(19) United States
(12) Patent Application Publication
(10) Pub. No.: US 2007/0254709 A1
(43) Pub. Date: Nov. 1, 2007

(54) METHOD AND SYSTEM FOR UNAMBIGUOUS ACCESSORY ASSOCIATION

(75) Inventor: Robert J. Higgins, Plantation, FL (US)

Correspondence Address: MOTOROLA, INC;INTELLECTUAL PROPERTY SECTION, LAW DEPT, 8000 WEST SUNRISE BLVD, FT LAUDERDAL, FL, 33322, US

(73) Assignee: MOTOROLA, INC., Plantation, FL (US)

(21) Appl. No.: 11/380,876

(22) Filed: Apr. 28, 2006

(51) Int. Cl. H04B 1/38

(52) U.S. Cl. 455/557

(57) ABSTRACT

A system (100) and method (400) for unambiguous wireless accessory association between a host device (102) having an optional transceiver (202) and a wireless accessory (110) can include a wireless adaptor (104), a transducer (103 or 106 or 114), and a processor (200) coupled to the wireless adaptor. The processor can be programmed to cause the wireless adaptor to selectively enter (402) a discovery mode, temporarily select (406) a first accessory that responds to the discovery mode, cause (408) the transducer to emit an identity signal detectable only within an unambiguous range, examine (412) a sensed incoming signal to confirm the first accessory is within the unambiguous range, and discontinue discovery (414) and select the first accessory if the sensed incoming signal is determined by the processor to have high similarity to the identity signal.

### FIELD

This invention relates generally to communication systems, and more particularly to a method and system of unambiguous accessory device discovery.

### BACKGROUND

In present wireless accessory designs, one of the most common applications is the use of a wireless headset. For example, wireless headsets are often used as accessories for two-way radios. One of the problems associated with creating a wireless headset accessory for a host device, such as a two-way radio, is that the wireless adapter for the radio typically has a very limited user interface, such as a button or LED, making it difficult to pair the host device and the wireless accessory in an unambiguous manner. Such a limited user interface along with the possible presence of other similar wireless devices in the area, further complicates an appropriate pairing between the headset and the wireless adapter at the radio.

The well developed Bluetooth technology of device discovery, device selection, and device authorization includes steps for pairing a Bluetooth headset with a host device, but not necessarily in a simple, unambiguous fashion. The user of a Bluetooth device may be required to narrow the scope of device discovery by selecting a device category (such as a headset) to discover. Device selection means that the user has to pick from the discovered set of connectable devices discovered in his or her wireless unit's radio range (typically 10 meters for Bluetooth). Further, the device authorization can involve entering a security Personal Identification Number (PIN) to access the device to prevent general access to the user's accessory. However, even in cellular phones having a good user interface (keypad and display) standard PIN codes (such as “0000” and “1234”) are used to simplify the operation at the expense of security.

Still, it is possible, and even probable that there may be an ambiguity as to which headset to select when several users have headsets in the same area or vicinity. To deal with this problem, device manufacturers have become accustomed to having the user press a button on the wireless adapter, and press a button on the accessory within a small timeframe, thereby signaling the desired device selection by the proximity in button presses. The result is a sequence that is inconvenient when a user's hands are busy, somewhat ambiguous, and insecure. In fact, due to such simplifications, many Bluetooth devices are made further susceptible to surreptitious hacking.

Accordingly, there is a need for a simple, unambiguous means of associating a wireless accessory with a communication device.

### SUMMARY

Embodiments in accordance with the present invention provide a simple means of device association that eliminates ambiguity and security issues associated with wireless accessory systems. While ambiguity and security issues are problems associated with Bluetooth and Bluetooth-like wireless accessory systems, the embodiments provided herein are not limited to these systems.

In a first embodiment of the present invention, a system for unambiguous wireless accessory association between a host device and a wireless accessory can include a wireless adaptor, a transducer coupled to the wireless adaptor, a transducer coupled to the wireless accessory, and a processor coupled to the wireless adaptor. The processor can be programmed to cause the wireless adaptor to selectively enter a discovery mode, temporarily select a first accessory that responds to the discovery mode to establish a wireless connection between the wireless adaptor and the first accessory, cause the transducer at the wireless adaptor or the wireless accessory to emit an identity signal detectable only within an unambiguous range, examine a sensed incoming signal to confirm the first accessory is within the unambiguous range, and discontinue discovery and select the first accessory if the sensed incoming signal is determined by the processor to have high similarity to the identity signal.

The processor can be further programmed to continue examining the sensed incoming signal for similarity to the identity signal if similarity to the identity signal is not detected and enter the discovery mode again only if the first accessory is tentatively selected and similarity to the identity signal is not detected. The processor can also be programmed to continue examining the sensed incoming signal for similarity to the identity signal and if similarity to the identity signal is not detected, to select a next accessory that responds to the discovery mode if more than one accessory is discovered. The processor can be programmed to cause continued emission of an identity signal and to continue examining the sensed incoming signal for similarity to the emitted identity signal for a predetermined time. The processor can also be programmed to cause the transducer to emit a different signal each time the transducer is activated for the purpose of unambiguous wireless accessory association where the identity signal is a sound, a tone, an infrared light signal, a Near-Field Magnetic (NFM) signal or a pulsed light signal, or other signal detectable only within the unambiguous range. The processor can also cause a transducer at the wireless adaptor to emit the identity signal as an acoustic signal that is sensed at a microphone at the wireless accessory which causes the wireless accessory to provide a real time representation of the sensed acoustic signal as the sensed incoming signal. The processor can also cause the transducer at the wireless accessory to emit the identity signal as an acoustic signal or a digital signal to be sensed at the wireless adaptor as the sensed incoming signal. Once the sensed identity signal has been detected, the processor can also be further programmed to place the wireless connection in a suspended state until the wireless connection is desired.

Note, the wireless accessory can be a wireless headset for a host device such as a two-way radio or other communication device, but can also be a wireless headset for any other electronic device such as an MP3 player. The wireless adaptor can be separate from a host device or it can be integrated and form a portion of a two-way radio (having its own transceiver) for example where the transducer can be the two-way radio's main speaker or microphone. The transducer can be a piezoelectric device either on the host device or the wireless adaptor. The system can further include a wireless accessory button that enables the wireless accessory to enter the discovery mode in response to activation of the wireless accessory button.

In a second embodiment of the present invention, a system for unambiguous wireless accessory association or pairing between a host device (optionally having a transceiver) and a wireless accessory can include a wireless adaptor coupled to the host device, a signal generator coupled to the wireless adaptor, and a processor coupled to the wireless adaptor. The processor is programmed to cause the wireless adaptor to selectively enter a discovery mode, temporarily select a first accessory that responds to the discovery mode to establish a temporary link between the wireless adaptor and the first accessory, cause the signal generator to emit a localized identity signal from a transducer coupled to the wireless adapter, examine an incoming signal from the temporary link to the first wireless accessory to confirm that the first accessory is sensing the identity signal, and continue using the temporary link as permanent between the first accessory if the wireless accessory is determined to be sensing the identity signal.

As noted above, the wireless accessory can be a wireless headset for a communication device. The signal generator can be a processor capable of generating a digital or analog identity signal. The signal generator can include an emitter that can be a modulatable light source such as a visible or infrared LED, an acoustic tone generator such as a resonant piezoelectric sounder, or an acoustic sound transducer such as a loudspeaker. The processor can further be programmed to cause the signal generator to produce a different identity signal (of a different frequency, for example) each time the signal generator is activated for the purpose of unambiguous wireless accessory association.

In a third embodiment of the present invention, a method for unambiguous wireless accessory association between a host device coupled to a wireless adaptor and a wireless accessory can include the steps of selectively entering a discovery mode, temporarily selecting a first accessory that responds to the discovery mode to establish a wireless connection between the wireless adaptor or host device and the first accessory, causing a transducer at the wireless adaptor or host device or the wireless accessory to emit an identity signal detectable only within an unambiguous range, examine a sensed incoming signal to confirm that the first accessory is within the unambiguous range, and discontinue discovery and select the first accessory if the sensed incoming signal is received at the wireless adaptor or the host device and is determined by the processor to have high similarity to the identity signal. The method can further include the step of causing the transducer at the wireless adaptor to emit the identity signal as an acoustic signal to be sensed at a microphone at the wireless accessory which causes the wireless accessory to provide a real time representation of the sensed acoustic signal as the sensed incoming signal at the wireless adaptor via the wireless connection. The method can also cause the transducer at the wireless accessory to emit the identity signal as an acoustic signal or a digital signal which is sensed at the wireless adaptor as the sensed incoming signal. The method can also alternatively cause the transducer at the host device, the wireless adaptor or the wireless accessory to emit a different signal each time the transducer is activated for the purpose of unambiguous wireless accessory association. The method can also include the step of entering the discovery mode in response to an activation of a wireless accessory button.

Other embodiments, when configured in accordance with the inventive arrangements disclosed herein, can include a system for performing the various processes and methods disclosed herein and a machine readable storage for causing a machine to perform the various processes and methods disclosed herein.

The terms “a” or “an,” as used herein, are defined as one or more than one. The term “plurality,” as used herein, is defined as two or more than two. The term “another,” as used herein, is defined as at least a second or more. The terms “including” and/or “having,” as used herein, are defined as comprising (i.e., open language). The term “coupled,” as used herein, is defined as connected, although not necessarily directly, and not necessarily mechanically. The term “suppressing” can be defined as reducing or removing, either partially or completely.

The terms “program,” “software application,” and the like as used herein, are defined as a sequence of instructions designed for execution on a computer system. A program, computer program, or software application may include a subroutine, a function, a procedure, an object method, an object implementation, an executable application, an applet, a servlet, a source code, an object code, a shared library/dynamic load library and/or other sequence of instructions designed for execution on a computer system.

### BRIEF DESCRIPTION OF THE DRAWINGS

FIG. 1 is an illustration of a system for unambiguous wireless accessory association between a host device having a transceiver and a wireless accessory in accordance with an embodiment of the present invention.

FIG. 2 is a block diagram of the system of FIG. 1 in a first mode of operation in accordance with an embodiment of the present invention.

FIG. 3 is a block diagram of the system of FIG. 1 in a second mode of operation in accordance with an embodiment of the present invention.

FIG. 4 is a flow chart illustrating a method for unambiguous wireless accessory association between a host device coupled to a wireless adaptor and a wireless accessory.

### DETAILED DESCRIPTION OF THE DRAWINGS

While the specification concludes with claims defining the features of embodiments of the invention that are regarded as novel, it is believed that the invention will be better understood from a consideration of the following description in conjunction with the figures, in which like reference numerals are carried forward.

The methods and systems in the embodiments herein provide a simple means of device association or pairing that essentially eliminates ambiguity (possible connection to the wrong wireless accessory) and potential security problems (blocks known unauthorized security breaching techniques). Embodiments herein provide a simple addition to a wireless system that can simplify the device association process, particularly when there is a limited user interface (UI), significantly decrease the association ambiguity when other wireless accessories are present, and improve security by preventing most known forms of RF hacking (unauthorized, surreptitious connection to the host).

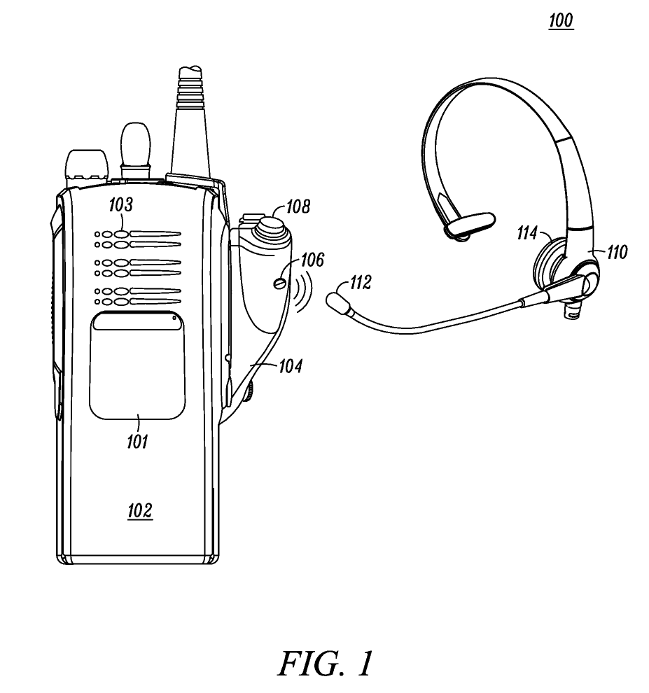

Referring to FIGS. 1-3, a system 100 for unambiguous wireless accessory association between a host device 102 having a transceiver 202 and a wireless accessory 110. The system 100 further includes a wireless adaptor 104 coupled to the transceiver 202 (via a processor 200), a transducer 103 or 106 coupled to the wireless adaptor 104, and a processor 200 coupled to the wireless adaptor 104. The host device can be a two-way radio, 102 having its own transceiver 202 for linking to an outside wide area system (not shown). A link 230 can exist between a transceiver 109 in the wireless adapter 104 which can have its own separate antenna and the transceiver 206. Communication from the wireless accessory's transceiver 206 can go to the wireless adapter's transceiver 109 and ultimately this communication (such as radio frequency data) can go through processor 200 (or processor 111) and over the transceiver 202 to an outside radio network. Of course, the host device can also be a device such as an MP3 player and communication can alternatively or optionally go from the wireless adaptor 104 (and transceiver 109) to the wireless accessory 110 (and transceiver 206). The wireless adapter 104 can be a complete radio system (typically in the ISM band at 2.4 GHz), in general having its own processor 111 and an antenna as shown. The wireless adaptor can couple to the host device or in a particular embodiment to a host radio which can be a separate complete radio system on a different frequency (50 MHz-2 GHz typically). If it is an adapter, the communication between the adapter and the radio may be an audio connection as though the adapter were a wired accessory. If the adapter is built into the radio, it will still have all of the same radio components, but the processor (200 or 111) that controls the link 230 could be in the main radio (102) instead of the separate processor 111 inside the “wireless adapter”. Because the adapter may have only an audio link into the two-way radio 102, it may not have in that case access to the radio's user interface (UI). However, some adapters may also include a data interface to the radio's processor in addition to the audio interface. In such a case it is possible for the adapter to potentially access the main radio's UI and transducers through data communications with the radio's processor 200.

The wireless adaptor 104 can be a separate device that couples physically and electrically to the host device 102 or can be incorporated into the host device 102 forming, for example, a two-way radio where the transducers can be the two-way radio's main speaker (103) and microphone (105). Note, even if the wireless adapter is not built into the radio, it is possible to use the radio's transducer by data communication through processor 200. The transducer (103, but more likely 106) can be a piezoelectric device either on the host device 102 or the wireless adaptor 104. As the prior example suggests, the wireless adaptor 104 can have its own resources or possibly share the resources of the host device. For example, the wireless adaptor can use processor 200 and transducer 103 or optionally have its own processor 111 or use its own transducer 106. The host device 102 can further include a user interface 101 (display, light indicators, keypad and the like) and a microphone 105 coupled to the processor 200. The wireless adaptor can also include a microphone 107 as well as a signal generator 204. Note that the transducers 103 or 106 can emit sound, but can alternatively emit light or other signals that would remain detectable only within an unambiguous range as will be further detailed below. Accordingly, the microphones 105 and 107 can alternatively be other types of receiving devices that can receive signals such as photo detectors and the like. The wireless accessory 110 can be a wireless headset for a communication device such as a two-radio and can also include a transceiver 206 (but not necessarily since it can just include a receiver instead in some embodiments), a processor 208, and an emitting transducer 114 and a receiving transducer 112 coupled to the processor 208. The system can further include a wireless accessory button 108 that enables the wireless adapter 104 to enter the discovery mode in response to activation of the wireless accessory button 108.

Functionally, button 108 can have a dual use utilizing the processor 111 in the wireless adapter 104. If no link is formed, pushing the button can cause the wireless adapter to go into discovery mode. Once a wireless accessory is paired, and subsequently an audio link is established, pushing this same button could cause a push-to-talk (PTT) signal. When an accessory is discovered, an audio link is formed, and then the processor 111 causes the signal generator to create an identity signal which is emitted as a sound by transducer 106. The emitted sound can be picked up in the microphone in the headset, a representation of which is sent back down via wireless link 230 to the wireless adapter 104. The processor 111 in the wireless adapter (or in the radio if it is in control of such functions) can compare the identity signal it created to the representation that is returned from the wireless downlink. If the two match, then it is the correct accessory. If no matching signal is received, the link is disconnected and discovery would continue looking for another device. If no other device is found in a certain length of time, the same headset can be tried again, presuming that the first time the user did not place it close enough to the wireless adapter to be within the unambiguous range.

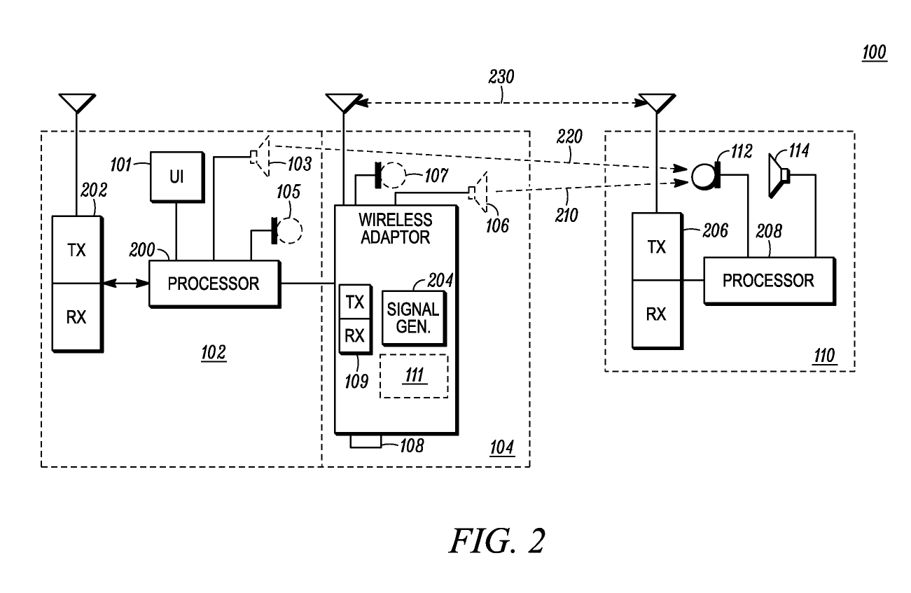

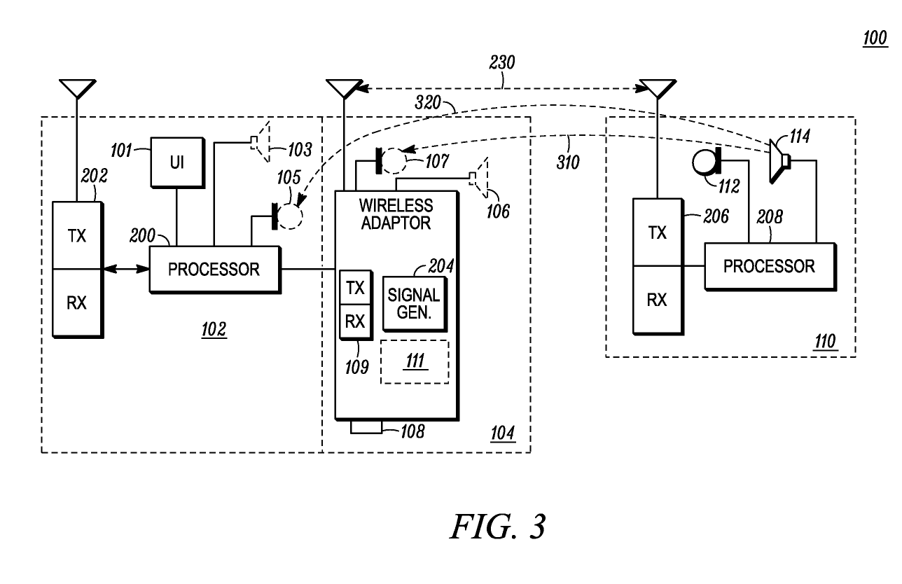

The processor 200 can be programmed to cause the wireless adapter to enter a discovery mode, temporarily select a first accessory (such as wireless accessory 110) that responds to the discovery mode to establish a wireless audio connection 230 between the wireless adaptor 104 and the first accessory 110, cause the transducer (either 103, 106 in FIG. 2, or 114 in FIG. 3) to emit an identity signal detectable only within an unambiguous range, examine an incoming signal at the host device 102 or the wireless adaptor 104 for a sensed signal to confirm the first accessory is picking up the identity signal within the unambiguous range, and discontinue discovery and select the first accessory 110 if a match to the identity signal is received at the wireless adaptor 104 or the host device 102.

Referring to FIGS. 2 and 3, the transducer 103 or 106 of FIG. 2 can emit an identity signal 220 or 210 or some other signal that will have a controlled range of detectability for sensing at transducer 112. The emitting transducer 114 of FIG. 3 can emit an identity signal 310 or 320 for sensing by transducers 105 or 107. In use according to the embodiments of FIG. 2, the emitted signal will be sensed by sensing transducer 112 in wireless accessory 110. In use according to the embodiments of FIG. 3, the emitted signal will be sensed by sensing transducer 105 in host device 102 or transducer 107 in wireless adapter 104.

In FIG. 2, by virtue of the wireless link established between wireless adapter 104 and wireless accessory 110, a representation of the signal sensed at 112 is transmitted over downlink path 230 and is received by transceiver 109 in the wireless adapter. In FIG. 3, by virtue of the wireless link established between wireless adapter 104 and wireless accessory 110, a representation of the identity signal to be emitted by transducer 114 is transmitted over link path 230 and is received by transceiver 206 in the wireless accessory 110.

In FIG. 2, the sensed signal representation is compared against the original signal emitted by transducer 103 or 106. If a substantial match is calculated in processor 200 or a processor that may exist in the wireless adapter 104 by comparison or correlation methods known in the art, then the wireless accessory linked to the wireless adapter 104 will have been determined to be within the unambiguous range of the wireless adapter 104. In FIG. 3, the sensed signal representation is compared against the original identity signal representation sent by transceiver 109 via link 230 for emission by transducer 114. If a substantial match is calculated in processor 206 by comparison or correlation methods known in the art, then the wireless adapter linked to the wireless accessory 110 will have been determined to be within the unambiguous range of the wireless accessory 110.

As an example, the signal emitted by the wireless adapter may consist of an audio waveform emitted at a low level by a small loudspeaker 106 in the wireless adapter 104. The emitted low level signal 210, now acoustic, propagates in air over a short range to microphone 112 in wireless accessory 110. Microphone 112 senses the acoustic signal 210 converting it to an electrical representation. Processor 208 directs the electrical representation of signal 210 over transceiver 206 via wireless path 230 to transceiver 109 in the wireless adapter. The received signal representation is compared by correlation for example with the signal originally generated in the wireless adapter for emission by transducer 106. If the signals are found to be above a predetermined threshold of similarity by the processor in the wireless adapter, then the processor declares that the wireless accessory which is linked is within the unambiguous range. Having been determined to be within the unambiguous range, the linked wireless accessory is determined to be the desired wireless accessory. Had the linked wireless accessory been farther away, perhaps out of view by the user, the accessory would not detect signal 210 and the comparison of the signal returned to the signal emitted would fail to exceed the threshold of similarity and will be determined to be outside the unambiguous range and will be presumed to not be the wireless accessory the user wishes to pair with the wireless adapter 104.

The identity signal is emitted within an unambiguous range, typically within sight of a user or within a personal area network of a user to avoid any interloping or hacking by unintended third parties. The identity can be a low volume sound, tone, or acoustic sound or infrared light, or pulsed or modulated light or other non-radio-frequency signal that would be emitted within the unambiguous range outside the purview of unintended third parties. The unambiguous range can typically be within 1 foot to 1 meter for example, but is not necessarily limited to such distance. It is not necessarily intended to cover the longer range distances covered by a radio frequency connection 230 such as those provided by the Bluetooth specification.

Again, embodiments herein provide a simplified means of wireless device association without sacrificing security. In one particular embodiment as disclosed above, the wireless radio adapter 104 can be modified to have a small audio transducer 106 such as a resonant piezoelectric “buzzer” (narrowband) transducer that can emit a low volume sound or tone. Such a transducer could be driven from a logic general purpose input/output (GPIO) port on a wireless controller IC or processor (such as processor 111) in the wireless adapter to provide an output tone on command.

Operationally, the wireless adaptor 104 and the wireless accessory 110 can be paired in a simplified process that can begin with a user turning on the host device 102 or radio in a particular example. The user can activate the accessory button 108 and place the desired accessory (wireless headset) 110 in close proximity to the wireless adaptor 104. The wireless adaptor 104 enters discovery mode over its wireless channel and perhaps many headset (or other wireless accessories) are discovered. The wireless adapter 104 can select the first headset to respond to the discovery and establish an audio connection. The audio connection can be duplex and temporary, but does not necessarily need to be duplex. In one particular embodiment, the wireless adaptor 104 can emit or play a signal such as a low volume sound or tone at its transducer 106. For security purposes, the signal can be different (e.g., different frequency) for each attempt at pairing. The wireless adapter 104 can then examine the incoming signal such as the incoming microphone audio signal to find evidence that the headset is picking up the emitted signal. This could be done as described above by correlation of the incoming audio with the transmitted tone such as a test that would insure that the received tone is the same frequency as the transmitted tone.

Alternatively, a data signal or other trigger signal can be sent either acoustically or even over the radio frequency link 230 that causes the wireless accessory 110 to respond with a predetermined signal expected back at the wireless adaptor 104 only detectable within the unambiguous range. In any event, if the tone is received, then the desired headset has been found and the link can be put into a suspended state until the link is needed. If the tone is not received in the incoming audio from the tentatively paired headset, and only one device had been discovered, the test can be continued for some length of time until a timeout has occurred. At this event, the pairing process failed and the whole process could be re-started automatically or manually. If the tone is not received in the incoming audio from the tentatively paired headset, and there is more than one discovered headset, then the link will be discontinued from the first headset and an audio link will be established with a second headset whereupon the wireless adapter 104 once again can examine the incoming microphone audio for the tone it emitted.

The system would exit the process described above having unambiguously paired the wireless adapter 104 with the wireless accessory or headset 110 of choice, rejecting other devices and providing improved security. It is unambiguous because the user is only going to place the desired headset microphone near the wireless radio adapter's emitter (tone emitter, RF emitter or otherwise). The process above has improved security since a hacker's long range radio frequency techniques to masquerade as a headset would be foiled since such hacker cannot hear the tone supplied by the wireless radio adapter in the pairing process, and hence would be rejected by the wireless radio adapter in the emitted tone test.

By allowing all headsets discovered to be possible choices and then automatically testing the headsets to find the correct headset (the correct one picks up the emitted signal or sound) the user's interaction in pairing is greatly simplified. The user would only need to press one button and place the desired headset near his or her wireless radio adapter and the system would select the correct link in an unambiguous manner.

In an embodiment where a “predetermined signal” is expected back at the wireless adaptor 104 as mentioned above, the wireless adapter 104 could establish a data link (not audio link) with the wireless accessory 110 to trigger or direct the wireless accessory 110 to send out identity signal “X” over its speaker. Identity signal, “X”, can be a signal selected from a predetermined set having been installed in the wireless accessory during manufacture, or in accessory customization by the user. The predetermined signals can be for example designated as signal 1 with a 1000 Hz sinusoid, signal 2 with a 2000 Hz sinusoid, signal 3 with a 500 Hz sinusoid, signal 4 with a 500 Hz+1200 Hz two-tone composite and so on. The wireless adapter and the accessory would each know what the list of signals are apriori. The wireless accessory, upon receiving this data message can synthesize the identity signal “X” (i.e., signal 1, signal 2, etc.) and play it out its speaker. Then the wireless adapter 104 can compare what it picks up or senses in its microphone 107 to a version of identity signal “X” that it synthesizes in its processor 111 and determine whether there is a substantial match. This embodiment relies on coordination in the design of the accessory and the wireless adapter to have a shared knowledge of the predetermined signals. In some respects, this method has somewhat reduced security because the predetermined signals can be well known in advance. This concept can also operate similarly in reverse, but then the processor 208 in the wireless accessory 110 would determine if there was a match.

In an inexpensive embodiment, a simple audio emitter can be added to the wireless radio adapter that is excited to produce a random frequency acoustic tone which is picked up by the target headset by placing its microphone in close proximity to the wireless adapter. The adapter will test its headset selection by establishing an audio link and comparing the received microphone signal to the emitted tone. This test insures a high degree of proximity to the wireless adapter within an unambiguous range to avoid pairing in error with an undesired headset within its RF range. (Note, a hacker or surreptitious interloper can be ½ mile away with a high gain antenna and be within RF range, but using the embodiments herein will foil such attempts since non-RF short range signaling is used for the purpose of pairing).

Presently, systems are being designed for mission critical wireless accessories and for non-mission critical accessories. The system described above can work for either type of accessories, provided the wireless radio adapter is designed to offer this feature. Since the wireless radio adapter must be designed to fit onto or into the radio, it is likely that the wireless radio adapter portion of the system will be customized. This system can also be used with headsets that are off-the-shelf with no modifications.

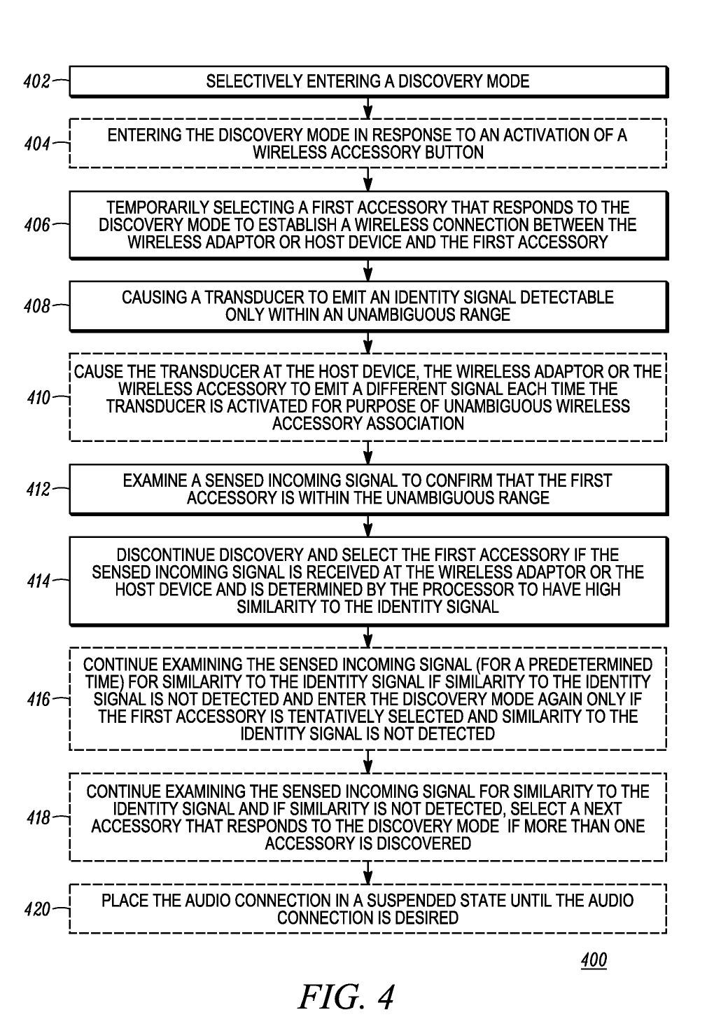

Referring to FIG. 4, a method 400 for unambiguous wireless accessory association between host device coupled to a wireless adaptor and a wireless accessory can include the step 402 of selectively entering a discovery mode, temporarily selecting a first accessory that responds to the discovery mode to establish a wireless connection between the wireless adaptor or host device and the first accessory at step 406, causing a transducer to emit an identity signal detectable only within an unambiguous range at step 408, examining a sensed incoming signal to confirm the first accessory is within the unambiguous range at step 412, and complete or discontinue discovery and select the first accessory if the sensed incoming signal is received at the wireless adaptor or the host device and is determined by the processor to have a high similarity to the identity signal at step 414. The method can further include the step of continuing to examine at step 416 the sensed incoming signal (for a predetermined time) for similarity to the identity signal if similarity to the identity signal is not detected and enter the discovery mode again only if the first accessory is tentatively selected and similarity to the identity signal is not detected. Optionally, the method can also continue examining at step 418 the sensed incoming signal for similarity to the identity signal and if similarity is not detected, selecting a next accessory that responds to the discovery mode (within the unambiguous range) if more than one accessory is discovered. The method can also optionally enter the discovery mode in response to an activation of a wireless accessory button at step 404 or place the audio connection in a suspended state until an audio connection is desired at step 420. The method can further cause the transducer at the host device, the wireless adaptor or the wireless accessory to emit a different signal each time the transducer is activated for the purpose of unambiguous wireless accessory association at step 410.

In light of the foregoing description, it should be recognized that embodiments in accordance with the present invention can be realized in hardware, software, or a combination of hardware and software. A network or system according to the present invention can be realized in a centralized fashion in one computer system or processor, or in a distributed fashion where different elements are spread across several interconnected computer systems or processors (such as a microprocessor and a DSP). Any kind of computer system, or other apparatus adapted for carrying out the functions described herein, is suited. A typical combination of hardware and software could be a general purpose computer system with a computer program that, when being loaded and executed, controls the computer system such that it carries out the functions described herein.

In light of the foregoing description, it should also be recognized that embodiments in accordance with the present invention can be realized in numerous configurations contemplated to be within the scope and spirit of the claims. Additionally, the description above is intended by way of example only and is not intended to limit the present invention in any way, except as set forth in the following claims.

What is claimed is:

1. A system for unambiguous wireless accessory association between a host device and a wireless accessory, comprising:
a wireless adaptor;
a transducer coupled to the wireless adaptor;
a transducer coupled to the wireless accessory; and
a processor coupled to the wireless adaptor, wherein the processor is programmed to:
cause the wireless adaptor to selectively enter a discovery mode;
temporarily select a first accessory that responds to the discovery mode to establish a wireless connection between the wireless adaptor and the first accessory;
cause the transducer at the wireless adaptor or the wireless accessory to emit an identity signal detectable only within an unambiguous range;
examine a sensed incoming signal to confirm the first accessory is within the unambiguous range; and
discontinue discovery and select the first accessory if the sensed incoming signal is determined by the processor to have high similarity to the identity signal.

2. The system of claim 1, wherein the processor is further programmed to continue examining the sensed incoming signal for similarity to the identity signal if similarity to the identity signal is not detected and enter the discovery mode again only if the first accessory is tentatively selected and similarity to the identity signal not detected.

3. The system of claim 1, wherein the processor is further programmed to continue examining the sensed incoming signal for similarity to the identity signal and if similarity to the identity signal is not detected, select a next accessory that responds to the discovery mode if more than one accessory is discovered.

4. The system of claim 1, wherein the processor is further programmed to cause continued emission of an identity signal and to continue examining the sensed incoming signal for similarity to the emitted identity signal for a predetermined time.

5. The system of claim 1, wherein the system further comprises a wireless accessory button, wherein the wireless adaptor enters the discovery mode in response to activation of the wireless accessory button.

6. The system of claim 1, wherein once the sensed identity signal has been detected, the processor is further programmed to place the wireless connection in a suspended state until the wireless connection is desired.

7. The system of claim 1, wherein the wireless adaptor is integrated with the transceiver that forms a portion of a two-way radio and the transducer is the two-way radio's main speaker or microphone.

8. The system of claim 1, wherein the transducer is a piezoelectric device.

9. The system of claim 1, wherein the processor is further programmed to cause the transducer to emit a different signal each time the transducer is activated for the purpose of unambiguous wireless accessory association wherein the identity signal is a sound, a tone, an infrared light signal, a Near-Field Magnetic (NFM) signal or a pulsed light signal, or other signal detectable only within the unambiguous range.

10. The system of claim 1, wherein the wireless accessory is a wireless headset for a communication device.

11. The system of claim 1, wherein the processor causes a transducer at the wireless adaptor to emit the identity signal as an acoustic signal that is sensed at a microphone at the wireless accessory which causes the wireless accessory to provide a real time representation of the sensed acoustic signal as the sensed incoming signal.

12. The system of claim 1, wherein the processor causes the transducer at the wireless accessory to emit the identity signal as an acoustic signal or a digital signal to be sensed at the wireless adaptor as the sensed incoming signal.

13. A system for unambiguous wireless accessory association between a host device having a transceiver and a wireless accessory, comprising:
a wireless adaptor coupled to the host device;
a signal generator coupled to the wireless adaptor; and
a processor coupled to the wireless adaptor, wherein the processor is programmed to:
cause the wireless adaptor to selectively enter a discovery mode;
temporarily select a first accessory that responds to the discovery mode to establish a temporary link between the wireless adaptor and the first accessory;
cause the signal generator to emit a localized identity signal from a transducer coupled to the wireless adapter;
examine an incoming signal from the temporary link to the first wireless accessory to confirm that the first accessory is sensing the identity signal; and
continue using the temporary link as permanent between the first accessory if the wireless accessory is determined to be sensing the identity signal.

14. The system of claim 13, wherein the signal generator is an infrared signal emitter, a tone signal emitter, a sound emitter, a Near-Field-Magnetic signal emitter, or a pulsing light signal emitter.

15. The system of claim 13, wherein the processor is further programmed to cause the signal generator to emit a different identity signal each time the signal generator is activated for the purpose of unambiguous wireless accessory association.

16. A method for unambiguous wireless accessory association between a host device coupled to a wireless adaptor and a wireless accessory, comprising the steps of:
selectively entering a discovery mode;
temporarily selecting a first accessory that responds to the discovery mode to establish a wireless connection between the wireless adaptor or host device and the first accessory;
causing a transducer at the wireless adaptor or host device or the wireless accessory to emit an identity signal detectable only within an unambiguous range;
examine a sensed incoming signal to confirm that the first accessory is within the unambiguous range; and
discontinue discovery and select the first accessory if the sensed incoming signal is received at the wireless adaptor or the host device and is determined by the processor to have high similarity to the identity signal.

17. The method of claim 16, wherein the method further comprises the step of causing the transducer at the wireless adaptor to emit the identity signal as an acoustic signal to be sensed at a microphone at the wireless accessory which causes the wireless accessory to provide a real time representation of the sensed acoustic signal as the sensed incoming signal at the wireless adaptor via the wireless connection.

18. The method of claim 16, wherein the method further comprises the step of causing the transducer at the wireless accessory to emit the identity signal as an acoustic signal or a digital signal which is sensed at the wireless adaptor as the sensed incoming signal.

19. The method of claim 16, wherein the method further comprises the step of entering the discovery mode in response to an activation of a wireless accessory button.

20. The method of claim 16, wherein the method further comprises the step of causing the transducer at the host device, the wireless adaptor or the wireless accessory to emit a different signal each time the transducer is activated for the purpose of unambiguous wireless accessory association.
